(19) United States
(12) Patent Application Publication
(10) Pub. No.: US 2017/0271982 A1
(43) Pub. Date: Sep. 21, 2017

(54) WIDE-VOLTAGE-RANGE, DIRECT RECTIFICATION, POWER SUPPLY WITH INDUCTIVE BOOST

(71) Applicants: Curtis J. Dicke, Colorado Springs, CO (US); Richard Alan Klinger, Colorado Springs, CO (US)

(72) Inventors: Curtis J. Dicke, Colorado Springs, CO (US); Richard Alan Klinger, Colorado Springs, CO (US)

(21) Appl. No.: 15/454,802

(22) Filed: Mar. 9, 2017

Related U.S. Application Data
(60) Provisional application No. 62/309,102, filed on Mar. 16, 2016.

(51) Int. Cl. H02M 3/04; H02M 1/14; H02M 7/06

(52) U.S. Cl. CPC H02M 3/04; H02M 7/06; H02M 1/14

(57) ABSTRACT

A power supply system has a full-wave rectifier feeding through an inductor having inductance between one and ten millineries to an energy storage capacitor; and a DC-to DC converter coupled to receive power from the energy storage capacitor. The inductor is configured to provide a peak voltage at the energy storage capacitor greater than a peak voltage at the output of the full-wave rectifier. In an embodiment, the DC-DC converter is a buck-type DC-DC downconverter.

### RELATED APPLICATIONS

This application claims the benefit of priority of U.S. Provisional Application No. 62/309,102 filed Mar. 16, 2016, the content of which is incorporated herein by reference in its entirety.

### BACKGROUND

Direct rectification, direct-current to direct-current (DC-DC) conversion, power supplies (DR DC-DC supplies) are commonly included with smartphone, tablet, netbook, notebook, and laptop computers. Typically, these DR DC-DC supplies have an architecture as illustrated in FIG. 1. A cable and connector 102 is provided for connection to an alternating current (AC) mains supply, to permit the AC mains supply to directly drive a full-wave bridge rectifier circuit formed of diodes 104, 106, 108, 110 and drive a high-voltage direct-current (DC) bus 111. A small ceramic capacitor 112 and a larger energy-storage capacitor 114 are provided to filter the high-voltage DC bus 111, which powers a DC-DC converter 116, the DC-DC converter provides one or more regulated outputs 118 of the power supply that may be connected to the smartphone, tablet, netbook, or notebook, or laptop computer.

In some such DR DC-DC supplies, DC-DC converter 116 is a buck-type DC-DC downconverter that requires high-voltage DC bus 111 remain above a minimum high-high voltage DC to continue functioning through an entire cycle of the AC mains supply; should high voltage DC bus droop below this minimum, regulated output 118 of the supply may be impaired. The difference between minimum operating voltages at high-voltage DC bus 111 and DC-DC converter output 118 is the “headroom” of the DC-DC converter. The lowest level to which the energy-storage capacitor 114 drops during each cycle is the droop level of the power supply.

Some such power supplies are expected to operate successfully in 50-cycle, 100-volt nominal, areas of Japan, despite voltage drops in the system that may lower available AC voltage to as low as 90 volts. Capacitor 114 must therefore store sufficient energy to sustain full DC-DC converter output for 10 milliseconds. Many such power supplies are also expected to work with much higher voltage AC inputs, such as the 250-V, 50 Hz sometimes found in Europe, implying capacity 114 must be rated for at least a 350-V working voltage, large capacitors of this working voltage tend to be both expensive, and leaky—leakage in this capacitor may impair operating efficiency of the power supply at high input voltage, low load, conditions.

### SUMMARY

In an embodiment, a power supply system has a full-wave rectifier feeding through an inductor having inductance between one and ten millihenries to an energy storage capacitor; and a DC-to DC converter coupled to receive power from the energy storage capacitor. The inductor is configured to provide a peak voltage at the energy storage capacitor greater than a peak voltage at the output of the full-wave rectifier. The DC-DC converter is a buck-type DC-DC downconverter in a particular embodiment.

In another embodiment, a method of providing power to a load includes Receiving and rectifying an AC power source to provide a pulsating DC power bus; and passing power from the pulsating DC power bus through an inductor and to an energy storage capacitor to provide a boosted high voltage DC power bus, and passing power from the DC power bus through a DC-DC converter to the load. In particular embodiment, the DC-DC converter is a buck-type downconverter, and the inductor and energy storage capacitor are configured such that at full load the boosted high voltage DC power bus has voltage peaks greater than voltage peaks of the pulsating DC power bus

### BRIEF DESCRIPTION OF THE FIGURES

FIG. 1 is a schematic diagram of a PRIOR ART direct-rectification AC with DC-DC power supply.

FIG. 2 is a schematic diagram of a new direct-rectification AC with DC-DC power supply.

FIG. 3A is a simulation plot of load current for a simulation, time axis is aligned with FIGS. 3B, 3C, and 3D.

FIG. 3B is a simulation plot of AC input voltage and energy storage capacitor voltage.

FIG. 3C is a simulation plot of inductor voltage.

FIG. 3D is a simulation plot of boosted high voltage DC bus 215 (FIG. 2).

FIG. 3E is a simulation plot of load current.

FIG. 3F is a simulation plot of a DC-DC converter output.

FIG. 3G is a simulation plot of boosted high voltage DC bus 215.

FIG. 4 is a schematic diagram of a PRIOR ART pi-filtered power supply.

FIG. 5 is an illustration of droop voltage versus capacitance for a 1-amp load.

FIG. 6 illustrates load-current dependency of boost voltage.

FIG. 7 illustrates dependence of boosted high voltage DC bus voltage with inductor value at a constant current and input AC voltage.

### DETAILED DESCRIPTION OF THE EMBODIMENTS

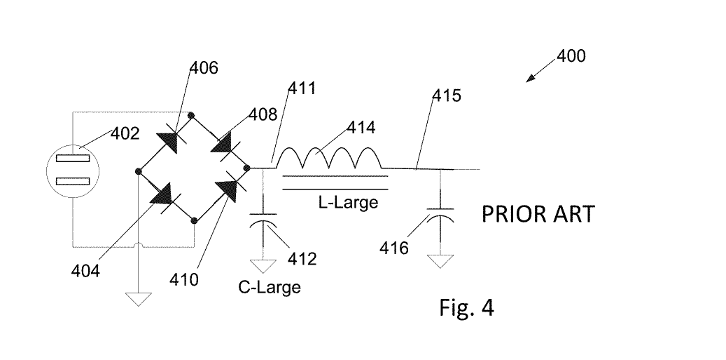

FIG. 4 is a schematic diagram of a PRIOR ART power supply of the type that uses a line-frequency choke to filter ripple from an output voltage.

A direct rectification power supply 200 (FIG. 2) has a cable and connector 202 for connection to an AC mains supply, to permit the AC mains supply to directly drive a full-wave bridge rectifier circuit formed of diodes 204, 206, 208, 210 and drive a high-voltage, pulsatile DC bus 211. A small capacitance 212, part or all of which is parasitic capacitance, may exist in the system in part to reduce sensitivity to radio frequency interference on the AC mains supply and to reduce interference coupled onto the AC mains from the DC-DC converter 218. An inductor 214 in the one to ten millihenry range is provided as a voltage boost inductor, and a larger energy-storage capacitor 216 are provided to boost and filter the high-voltage DC bus 211 into a boosted high-voltage DC bus 215, which powers a DC-DC converter 218 the DC-DC converter provides one or more regulated outputs 220 of the power supply that may be connected to the smartphone, tablet, netbook, or notebook, or laptop computer. To provide protection at high voltages against startup transients that may induce excessive boosted voltages due to high currents in inductor 214, a zener diode 224, in an embodiment of about 400 volt rating, is provided.

In some such DR DC-DC supplies, DC-DC converter 218 is a buck-type DC-DC downconverter typically having an output voltage between five and 110 volts DC; this buck-type downconverter may have a fixed regulated voltage output such as 18 volts for many laptop computers or 5 volts for many cell phones and tablet computers, or may embody a variable-voltage, current-limited output embodying a charging algorithm suitable for lithium or lead-acid storage batteries. In particular, embodiments configured to charge 48-volt batteries DC output 222 may reach nearly 60 volts, while in those adapted to charge 12-volt batteries voltage will be between ten and fifteen volts. In alternative DR DC-DC supplies, DC-DC converter 218 may be a buck-boost or a boost type converter providing high voltages for fluorescent lighting.

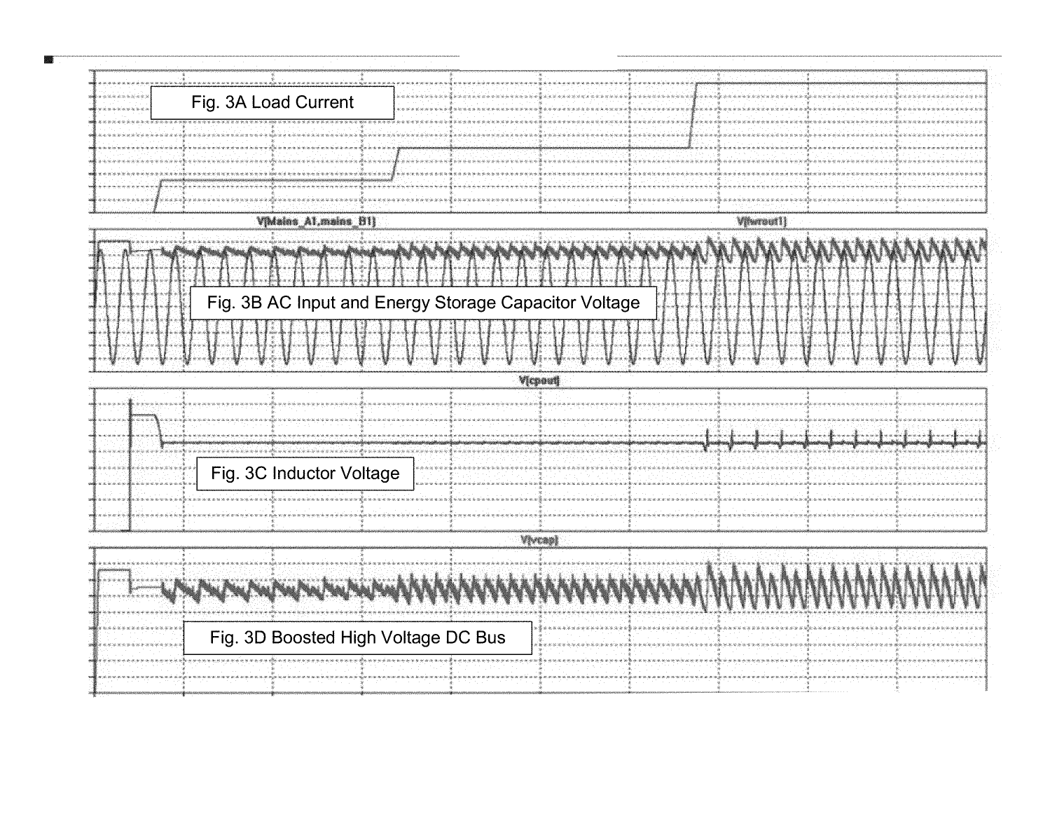

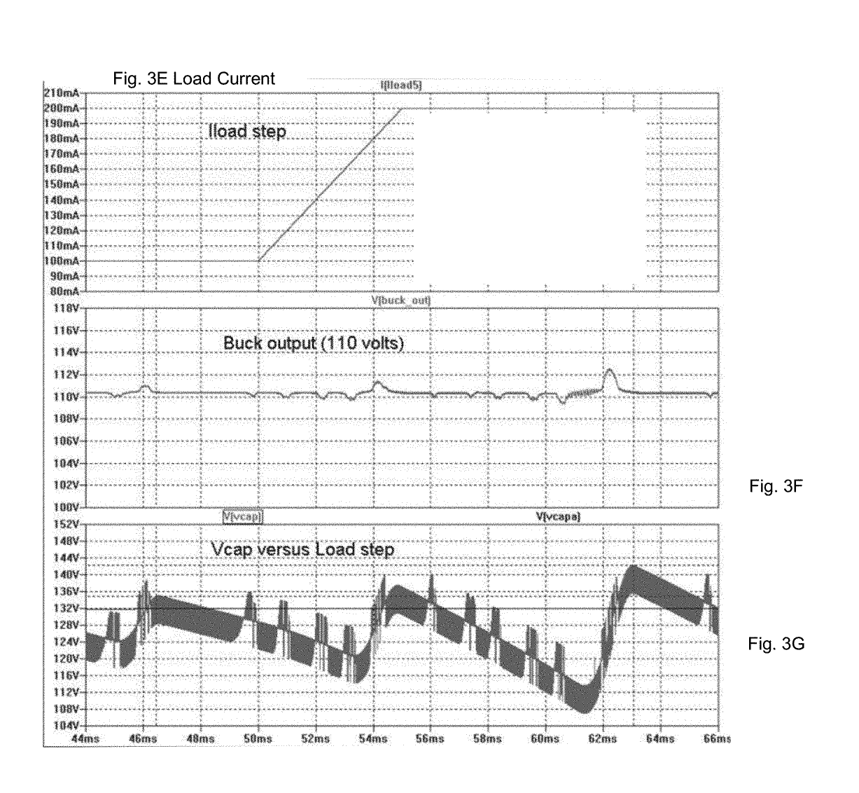

In operation at low currents, as portrayed in the left half of FIGS. 3A-3D, each voltage pulse from the AC source and rectifier 204-210 provides a current that passes through inductor 214 to boosted high-voltage DC bus 215. The high-voltage DC bus 215, as shown in FIG. 3D, ripples a small amount, energy storage in capacitor 216 is sufficient to keep this bus at a high enough voltage that DC-DC converter 218 may function continuously.

At higher currents, as portrayed in the right portion of FIGS. 3A-3D, current builds in inductor 214 during peaks of each half-cycle of AC input after pulsating high voltage DC bus 211 is driven above residual voltage on boosted high-voltage DC bus 215, and begins to charge capacitor 216. If inductor 214 were absent or a very low value, capacitor 216 would stop charging at the peak input voltage (minus a diode drop) of each cycle; but with inductor 214 present, capacitor 216 continues to charge briefly after high-voltage DC bus 211 reaches its peak value for each half cycle, and this continuation current causes boosted high-voltage DC bus 215 to reach, in some embodiments depending on exact component values, a voltage greater up to ten percent greater than that attained on high voltage DC bus 211. Essentially, the inductor stores energy which is released as current at the peak of the half-cycle, to a voltage dependent on how much energy was stored. In particular embodiments, input capacitor 212 has one tenth or less the capacity of energy-storage capacitor 216, as it primarily serves to bypass radio-frequency noise.

FIGS. 3E, 3F, and 3G are simulation plots at a higher-resolution timescale than FIGS. 3A-3D. Current of a load is shown in FIG. 3E. FIG. 3E shows an output of a particular DC-DC converter 218. FIG. 3G shows the effect of boost on boosted high-voltage DC bus 215 as current increases, with boosted high voltage DC bus at 142 volts under high load and 134 volts at low load.

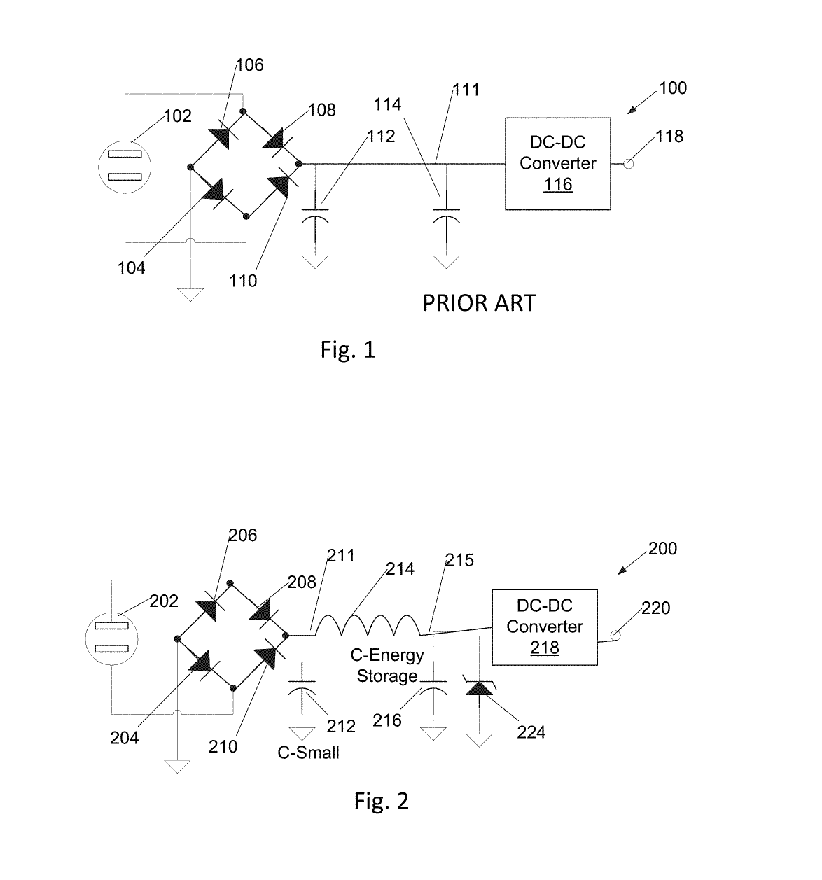

In a particular embodiment, simulated with 90 VAC input, we found 18 volts of additional headroom at high currents, permitting use of a significantly smaller energy storage capacitor 216 for the same maximum output current than would be required of capacitor 114 in the prior circuit of FIG. 1; in a 48-volt electric-bicycle charging embodiment, capacitor 216 may need only be ⅔ the size of capacitor 114.

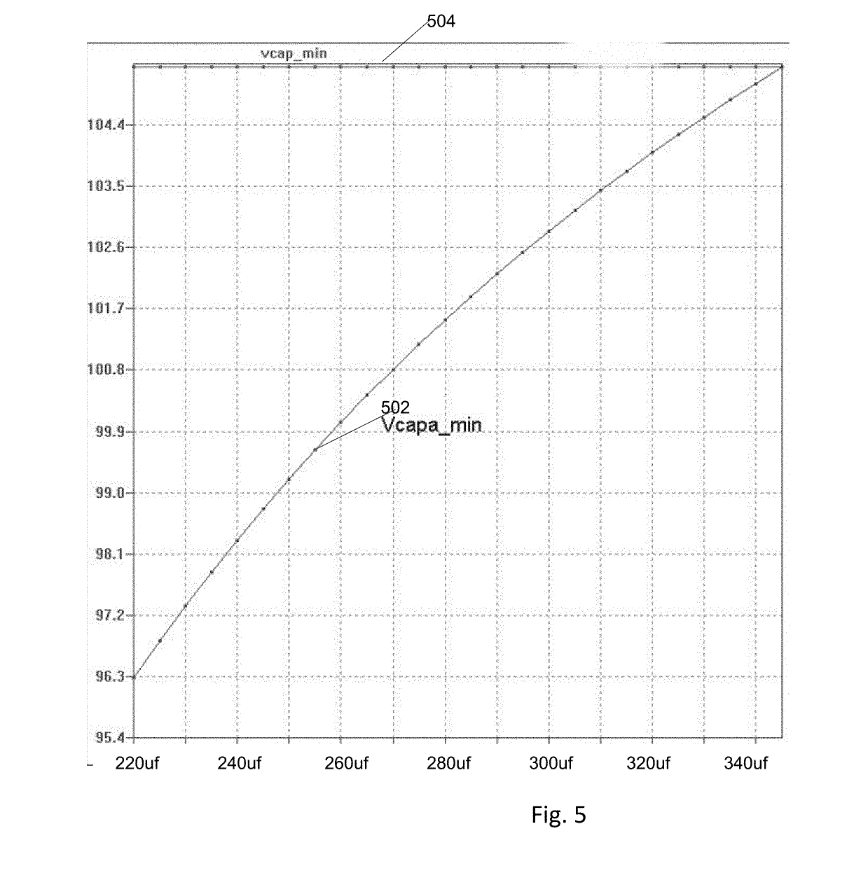

In a particular embodiment, with a one-ampere load at the boosted high voltage DC bus 215, droop reached 96.3 V as illustrated in FIG. 5 (Vcapa_min 502) with the circuit of FIG. 1 and a 220 uf. (220 microfarad) energy storage capacitor 114, and 104 volts with a 320 uf. capacitor; Vcap_min 504 illustrates droop at the same load current with boost inductor and a 220 uf energy storage capacitor in the circuit of FIG. 2. After applying roughly 10 volts of boost from a 2 millihenry inductor 214, minimum voltage during droop at the energy storage capacitor is roughly 104 volts with the 220 uf capacitor. The circuit of FIG. 2 can therefore be built with an energy storage capacitor roughly ⅔ the value of the energy storage capacitor needed with the circuit of FIG. 1 while providing similar power to a DC-DC converter.

While the circuit of FIG. 2 superficially resembles the PRIOR-ART full-wave pi-filtered power supply illustrated in FIG. 4, in both operation and component values it is significantly different. The power supply of FIG. 4, as further described online at http://www.circuitstoday.com/filter-circuits, has a line connector 402, a full-wave rectifier including diodes 404, 406, 408, 410, an input and energy-storage capacitor 412, an inductor 414, and a load-variation bypass capacitor 416. In the power supply illustrated in FIG. 4, which typically drives a relatively constant-current load such as class-A amplifiers, the primary energy storage capacitor for ripple reduction is input capacitor 412, The inductor 414 of a pi-filter is a line-frequency choke, typically having a value greater than ten millihenries, and in some systems lying between 200 millihenries and one henry, intended to provide high impedance at line-frequency ripple frequency. A second capacitor 416 is typically provided to bypass fluctuations in load currents.

It should be noted that in the circuit of FIG. 2, energy-storage capacitor 216 on the output side of the inductor serves as the primary energy-storage capacitor of the power supply, not the input capacitor 412, while capacitor 212 on the input side of the inductor is small and serves primarily to remove high frequency noise from the power line, and inductor 214 has value far less than typically used in the system of FIG. 4.

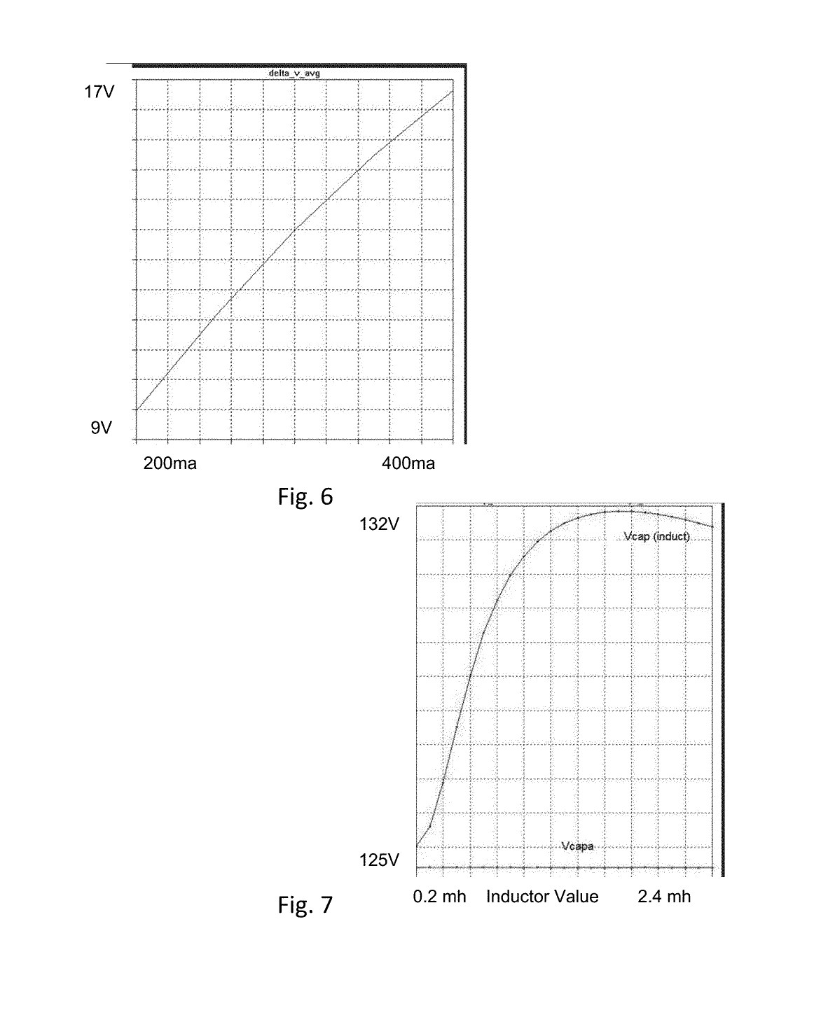

The amount of boost voltage, the difference in voltage at the energy storage capacitor 216 when inductor 214 is present and when the inductor is shorted out, increases with load current. FIG. 6 illustrates boost voltage with a high voltage DC bus of 133 volts and an inductor of 7.8 millihenries as current is increased from 200 to 400 milliamps. We note that it is at high load currents that droop from load current discharging the energy storage capacitor is most significant, this increase in boost at high load currents helps compensate for high load currents.

Sensitivity of the boosted high voltage DC bus voltage to inductance is illustrated in FIG. 7. With a 0.2 millihenry inductance, little boost is obtained and bus voltage at peaks of AC input is about 125, while with 2 millihenries, boosted high voltage DC reaches 132 volts at peaks. In embodiments, the inductor value is selected to be within the range of 1 to 10 millihenries, and in particular embodiments within the range of 1 to 3 millihenries; where the plot of FIG. 7 indicates function.

### CONCLUSION

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A power supply system comprising:
a full-wave rectifier,
an inductor having inductance greater than or equal to one millihenry and less than ten millihenries, the inductor coupled to an output of the rectifier and to an energy storage capacitor; and
a direct-current (DC)-to DC voltage converter coupled to receive power from the energy storage capacitor;
wherein the inductor is configured to provide a peak voltage at the energy storage capacitor that is greater than a peak voltage at the output of the full-wave rectifier.

2. The power supply of claim 1 configured for operation between 90 and 240 volts alternating-current (AC), 50 to 60 Hertz, at input to the full-wave rectifier.

3. The power supply of claim 1 wherein the DC-DC converter is a buck-type DC-DC downconverter.

4. A method of providing power to a load comprising:
receiving and rectifying an alternating-current (AC) power source to provide a pulsating direct-current (DC) power bus;
passing power from the pulsating DC power bus through an inductor and to an energy storage capacitor to provide a boosted high voltage DC power bus; and
passing power from the DC power bus through a DC-DC converter to the load.

5. The method of claim 4 wherein the inductor has value between 1 and 3 millihenries, the AC power source has frequency between 50 and 60 hertz.

6. The method of claim 5 wherein the DC-DC converter is a buck-type downconverter.

7. The method of claim 5 wherein the inductor and energy storage capacitor are configured such that at full load the boosted high voltage DC power bus has voltage peaks at a greater voltage than voltage peaks of the pulsating DC power bus.
